(19) United States
(12) Patent Application Publication
(10) Pub. No.: US 2020/0039220 A1
(43) Pub. Date: Feb. 6, 2020

(54) HEAD UNIT AND INKJET RECORDING APPARATUS

(71) Applicant: Konica Minolta, Inc., Tokyo (JP)

(72) Inventors: Kenichi YAMAMOTO, Tokyo (JP); Takeshi Urakami, Tokyo (JP); Yutaka Hokazono, Tokyo (JP); Akira Naruse, Toyohashi-shi (JP); Ryo Goto, Tokyo (JP)

(21) Appl. No.: 16/507,833

(22) Filed: Jul. 10, 2019

(30) Foreign Application Priority Data
Jul. 31, 2018 (JP) 2018-143323

(51) Int. Cl. B41J 2/145; B41J 25/34

(52) U.S. Cl. CPC B41J 2/145; B41J 25/34

(57) ABSTRACT

A head unit including: an inkjet head that ejects ink; and a fixer to which the inkjet head is fixed, wherein an engaging part is provided to be fixed to one of the inkjet head and the fixer, and an engaged part is provided to be fixed to the other, the inkjet head is fixed to the fixer by engaging the engaging part and the engaged part, and in the engaging part or the engaged part, a rigidity of a portion including one part of an engagement surface on which the engaging part and the engaged part engage with each other is lower than a rigidity of the other portion.

### BACKGROUND

### Technological Field

The present invention relates to a head unit and an inkjet recording apparatus.

### Description of the Related Art

There is an inkjet recording apparatus which ejects ink to various media and forms an image and/or a coating. By arranging and fixing a plurality of inkjet heads that have nozzles which eject ink and enabling ejection of ink in parallel from the plurality of inkjet heads, the speed and resolution of image recording operation by the inkjet recording apparatus are increased.

The plurality of inkjet heads are fixed to a fixer by using screws, pins or the like. In order to form images with a high accuracy, it is necessary to fix the plurality of inkjet heads in an accurate positional relationship. Elongated holes or the like have been conventionally used as receivers of the screws or pins to fix the inkjet heads in order to adjust the position of each of the inkjet heads. However, in this case, there is a problem that, even if the inkjet head was once fixed accurately, the inkjet head may be shifted from the fixed position due to a large force, shock or the like after an assembling step and after start of the image recording operation after the inkjet head was fixed.

There is known a technique of making the holes which are receivers have smaller diameters than those of screws or pins partially or entirely, and performing pressure fitting of fixing the screws or pins while deforming the holes of the receivers, and thereby continuously applying a force to the screws or pins from the receivers and making these positions, that is, the positions of the targets to be fixed difficult to shift (for example, JP 2004-268370 A, and JP H10-296984 A).

However, there is a problem that it is difficult to easily detach the inkjet head which was once attached from the fixer if the conventional technique is applied in a case where the inkjet head is attached to the fixer by performing positioning of the inkjet head to the fixer.

### SUMMARY

An object of the present invention is to provide a head unit and an inkjet recording apparatus in which the inkjet head can be attached and detached and can be fixed with highly accurate positioning.

To achieve at least one of the abovementioned objects, according to an aspect of the present invention, a head unit reflecting one aspect of the present invention includes: an inkjet head that ejects ink; and a fixer to which the inkjet head is fixed, wherein an engaging part is provided to be fixed to one of the inkjet head and the fixer, and an engaged part is provided to be fixed to the other, the inkjet head is fixed to the fixer by engaging the engaging part and the engaged part, and in the engaging part or the engaged part, a rigidity of a portion including one part of an engagement surface on which the engaging part and the engaged part engage with each other is lower than a rigidity of the other portion.

According to an aspect of the present invention, an inkjet recording apparatus reflecting one aspect of the present invention includes the above-mentioned head unit.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic view seen from a front side of the configuration of an inkjet recording apparatus;

FIG. 2 is a view seen from an upper side of the arrangement of inkjet heads in a head unit;

FIG. 3 is a perspective view of the inkjet head;

FIG. 4A is a bottom view of the inkjet head;

FIG. 4B is a front view of the inkjet head;

FIG. 5 is an enlarged view showing a part of a fixer;

FIG. 6 is a view for explaining fitting between a fitted part and a fitting part;

FIG. 7A is a view showing a modification example of the fitted part;

FIG. 7B is a view showing a modification example of the fitted part;

FIG. 7C is a view showing a modification example of the fitted part;

FIG. 7D is a view showing a modification example of the fitted part;

FIG. 8A is a view showing a bottom view of a modification example of the inkjet head;

FIG. 8B is a view showing a front view of the modification example of the inkjet head; and

FIG. 9 shows a modification example of a fixer.

### DETAILED DESCRIPTION OF EMBODIMENTS

Hereinafter, one or more embodiments of the present invention will be described with reference to the drawings. However, the scope of the invention is not limited to the disclosed embodiments.

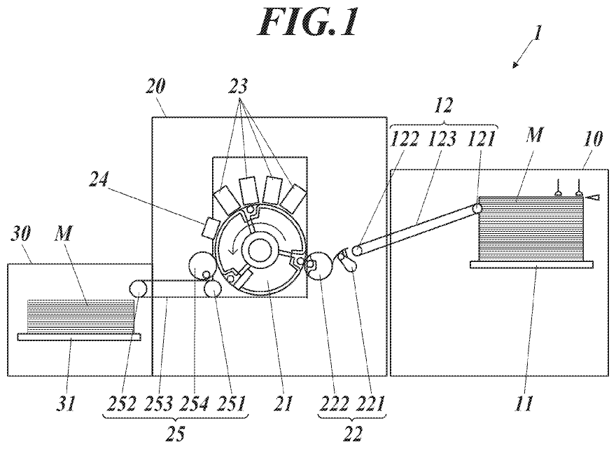

FIG. 1 is a schematic view seen from a front side of the configuration of an inkjet recording apparatus 1 in an embodiment of the present invention.

The inkjet recording apparatus 1 includes a medium feeder 10, a recording operator 20, a medium ejector 30, and the like. In this inkjet recording apparatus 1, based on the control operation by a controller not shown in the drawings, a recording medium M stored in the medium feeder 10 is conveyed to the recording operator 20 and ejected to the medium ejector 30 after the image is recorded.

The medium feeder 10 includes a medium feeding tray 11, a feeding conveyer 12, and the like.

The medium feeding tray 11 is a platy member on which one or more recording medium M can be placed. The medium feeding tray 11 is provided to move vertically according to the amount of the recording medium M mounted on the medium feeding tray 11, and the topmost recording medium M is held at the conveyance start position by the feeding conveyer 12. As for the recording medium M, various mediums, such as printing paper of various thickness, cel, film, and cloth can be used. The recording medium M may have the surface of a non-absorbable material in which ink does not penetrate.

The feeding conveyer 12 includes a plurality of, for example, two rollers 121, 122, a loop belt 123 which has the inner side supported by the rollers 121 and 122, and a feeder (not shown in the drawings) which passes the topmost recording medium M on the medium feeding tray 11 to the belt 123. The feeding conveyer 12 conveys the recording medium M which was passed onto the belt 123 by the feeder in accordance with the rotary movement of the belt 123 by the rotation of the rollers 121 and 122, and transmits the recording medium M to the recording operator 20.

The recording operator 20 includes an image forming drum 21, a passing unit 22, head units 23, a fixing unit 24, a deliverer 25, and the like.

The image forming drum 21 has the cylindrical outer circumferential shape, carries the recording medium M on the outer circumferential surface (conveyance surface), and conveys the recording medium M on the conveyance path according to the rotation operation. A heater may be provided on the internal surface of the image forming drum 21, and the conveyance surface may be heated so that the recording medium M placed on the conveyance surface is at a predetermined setting temperature.

The passing unit 22 passes the recording medium M which was passed from the feeding conveyer 12 to the image forming drum 21. The passing unit 22 is provided at a position between the feeding conveyer 12 of the medium feeder 10 and the image forming drum 21. The passing unit 22 has a claw 221 which holds one end of the recording medium M transmitted by the feeding conveyer 12, a cylindrical passing drum 222 which guides the recording medium M held by the claw 221, and the like. The recording medium M which was obtained from the feeding conveyer 12 by the claw 221 is transmitted to the passing drum 222, moved along the outer circumferential surface of the rotating passing drum 222, and guided and passed to the outer circumferential surface of the image forming drum 21.

Each of the head units 23 forms an image by ejecting ink droplets to points on the recording medium M, which moves relative to the head unit 23, from the plurality of nozzle openings provided on the ink ejection surface facing the recording medium M, according to the rotation of the image forming drum 21 which holds the recording medium M. In the inkjet recording apparatus 1 in the embodiment, four head units 23 are arranged at predetermined intervals, separating from the outer circumferential surface of the image forming drum 21 by a distance which was set in advance. The four head units 23 output ink of respective four colors of C, M, Y and K (cyan, magenta, yellow and black). In the embodiment, the ink of respective colors of C, M, Y and K is ejected in order from the upstream side in the conveyance direction of the recording medium M. Though an arbitrary ink can be used, in the embodiment, there is used ink which changes the phase between the sol state and the gel state according to the temperature and is fixed by emission of predetermined energy rays, for examples, ultraviolet rays. When the ink ejected from the head unit 23 in the sol state lands on the recording medium M, the temperature is lowered, and the ink promptly gets gel and increases the viscosity. Furthermore, the ink is fixed to the recording medium M by ultraviolet rays emitted from the fixing unit 24.

Each of the head units 23 in the embodiment is a line head which can form an image over the image recording width on the recording medium M by combination with the rotation of the image forming drum 21.

The fixing unit 24 emits the predetermined energy rays, which is ultraviolet rays in the embodiment as mentioned above, to the surface of the recording medium M. The fixing unit 24 has, for example, an LED lamp or the like which emits ultraviolet rays. The fixing unit 24 is arranged so as to be able to emit ultraviolet rays to the recording medium M near the outer circumferential surface of the image forming drum 21 in the range before passing of the recording medium M to the deliverer 25 from the image forming drum 21 after the ejection of ink from the head units 23 onto the recording medium M conveyed by the rotation of the image forming drum 21. The fixing unit 24 has a blocking member, and sufficiently lowers the emission amount of ultraviolet rays outside a predetermined range of the recording medium M on the conveyance surface, compared with the emission amount in the predetermined range.

The deliverer 25 conveys the recording medium M, to which ink was ejected and fixed, from the image forming drum 21 to the medium ejector 30. The deliverer 25 has a plurality of (for example, two) rollers 251, 252, a loop belt 253 which has the internal surface supported by the rollers 251, 252, cylindrical passing roller 254, and the like. The deliverer 25 guides the recording medium M on the image forming drum 21 onto the belt 253 by the passing roller 254, conveys the guided recording medium M by moving the recording medium M together with the belt 253 which is performing the rotary movement in accordance with the rotation of the rollers 251, 252, and sends out the recording medium M to the medium ejector 30.

The medium ejector 30 stores the recording medium M after image recording which was sent out from the recording operator 20 until the recording medium is taken out by the user. The medium ejector 30 has a platy medium ejection tray 31 or the like to place the recording medium M which was conveyed by the deliverer 25.

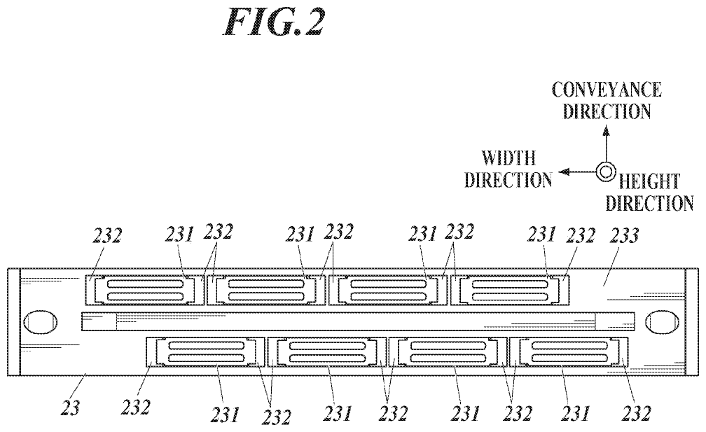

FIG. 2 is a view seen from above the arrangement of the inkjet heads 231 in the head unit 23. The described term “above” means the direction toward the opposite side to the ink ejection surface from the ink ejection surface of the head unit 23.

The head unit 23 is provided with a plurality of (for example, eight in the embodiment) inkjet heads 231 which eject ink, the inkjet heads 231 being arranged in order with overlapping portions along the width direction. The plurality of inkjet heads 231 are arranged in a staggered manner by making two rows in the conveyance direction, each of the rows extending in the width direction. The inkjet heads 231 are attached and fixed to the platy fixer 233. A flow path member 232 which passes ink to/from the inkjet head 231 is arranged at both ends in the width direction of each of the inkjet heads 231. An opening through which a drive substrate which supplies a drive signal and a voltage, for example, a flexible print substrate passes is provided to the upper surface of the inkjet head 231.

The fixer 233 is attached to a supporting member (carriage) which is not shown in the drawings, and held in an appropriate positional relationship with respect to the conveyance surface of the recording medium according to the state of the supporting member.

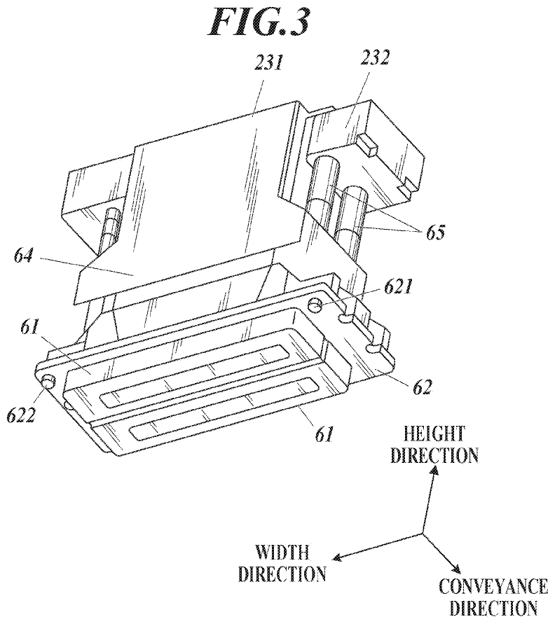

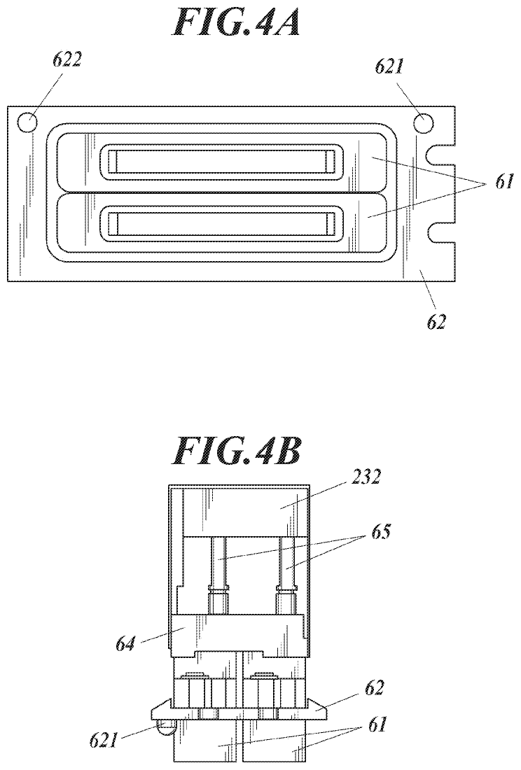

FIG. 3 is a perspective view of the inkjet head 231. FIG. 4A is a bottom view of the inkjet head 231, and FIG. 4B is a front view seen from one end in the width direction of the inkjet head 231.

The bottom surface of the inkjet head 231, that is, the side at the smallest (lowest) position coordinate in the height direction is the ink ejection surface. As shown in FIG. 4A, two nozzle substrates 61 are provided in parallel at different positions in the conveyance direction on the bottom surface of the substrate 62. A plurality of nozzles are arranged in the width direction on the bottom surface of the nozzle substrate 61. A main body 64 is provided on the upper surface side of the substrate 62. An ink flow path, a drive circuit and the like are provided in the main body 64. As shown in FIG. 4B, the nozzle substrates 61 penetrate the substrate 62 and are connected to the main body 64. The ink flow path is connected to a flow path member 232 via flow path connectors 65 protruding above the main body 64. Protruding fitting parts 621, 622 (engaging parts, insertion parts in the embodiment) are integrally (to be fixed) provided near respective ends in the width direction of the substrate 62 of the inkjet head 231 (“one” in the embodiment). Each of the fitting parts 621, 622 has a columnar structure from the root of the substrate 62, and its end is a convex curved surface structure.

FIG. 5 is an enlarged view of a part of the fixer 233.

FIG. 5 shows a state in which the inkjet head 231 is not attached.

The fixer 233 is provided with through holes 81. The arrangement of the through holes 81 is same as the arrangement of the inkjet heads 231. Each of the nozzle substrates 61 of the inkjet head 231 is inserted into and penetrates the through hole 81. The substrate 62 is larger than the through hole 81 and does not penetrate the through hole 81.

Fitted parts 234, 235 (engaged parts) are provided to both ends in the width direction of the through hole 81 of the fixer 233 (“the other” in the embodiment). In the embodiment, the fitted parts 234, 235 can be attached to and detached from the fixer 233, and provided to be fixed by fine adjustment of the positions with adjusters 84. The fitted parts 234, 235 have such shapes that respective bases 234a, 235a are connected to predetermined angle direction ranges (ranges less than 180 degrees in the embodiment) from the central positions (in the non-deformed state) of respective rings 234b, 235b. The ring 234b of the fitted part 234 surrounds a through hole 2341 (hole), which is located in the nearly central position, by a wall thinner than the base 234a. The ring 235b of the fitted part 235 surrounds a through hole 2351 (hole), which is located in the nearly central position, by a wall thinner than the base 235a. The through holes 2341, 2351 are provided at positions overlapping the respective through holes 81 in a plan view.

Two forcers 236 (forcers) are provided to one side of each of the through holes 81. The forcers 236 force the inkjet head 231, which has the nozzle substrates 61 inserted into the through hole 81, in the direction of the hollow arrow. The forcer 236 is a spring plate or the like which has one end fixed to the substrate 62.

Positioning is performed by inserting (engaging) the fitting parts 621, 622 into the through holes 2341, 2351 of the fitted parts 234, 235, and fitting and fixing are made.

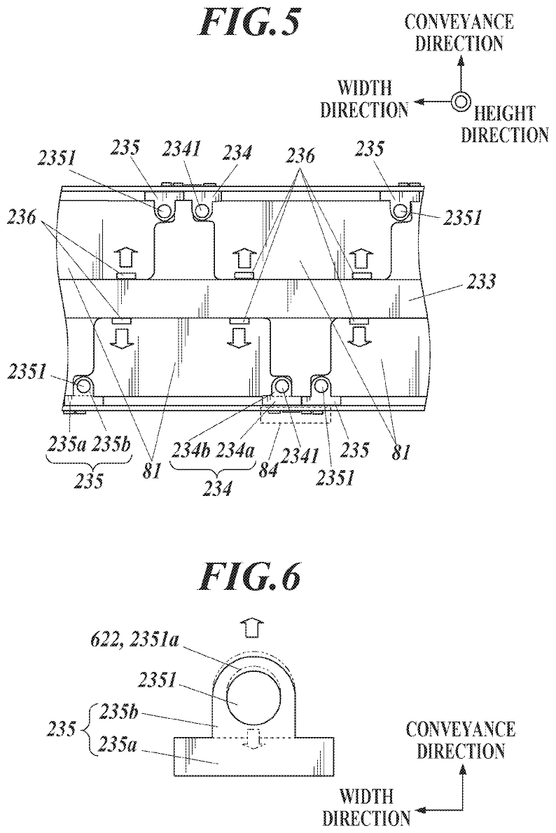

FIG. 6 is a view for explaining the fitting between the fitted part 235 and the fitting part 622.

Since the fitting between the fitted part 234 and the fitting part 621 and the fitting between the fitted part 235 and the fitting part 622 are similar, the explanation will be made for one of them.

The through hole 2351 provided to the ring 235b in the embodiment has a nearly round columnar shape in a state in which the fitting part 622 is not inserted. On the other hand, the columnar structure of the fitting part 622 has a major axis which is slightly longer than the diameter of the through hole 2351 and has a minor axis which is nearly same as the diameter of the through hole 2351. The fitting part 622 is inserted into the through hole 2351 so that the major axis passes through the direction in which the ring 235b is extending from the base 235a, in detail, the middle of the predetermined angle direction range. In the embodiment, the major axis direction is in parallel with the conveyance direction. That is, the cross section of the columnar structure which is in an oval shape (cross section in the plane orthogonal to the insertion direction of the fitting part 622) is larger than the same cross section of the circular through hole 2351. In other words, the cross section of the columnar structure includes the cross section of the through hole 2351.

The fitting part 621 is hardly deformed when it is inserted. On the other hand, the through hole 2351 is deformed in the expanding direction so as to enable the insertion of the fitting part 621. As mentioned above, the fitted part 235 is thick in the direction toward the base 235a from the through hole 2351, and the fitted part 235 is sufficiently thin, relatively to the direction toward the base 235a, in the direction toward the end of the ring 235b from the through hole 2351. That is, the fitted part 235 is divided into two of continuous one portion and the other portion according to the angle direction from the central position (position in a state in which the fitting part 621 is not inserted) of the through hole 2351 in the plane orthogonal to the height direction (insertion direction of the fitting parts 621, 622) with respect to the inner edge of the through hole 2351, that is, the contacting surface (engagement surface) with the fitting part 621. Each of the portions has a different rigidity corresponding to the thickness (in the embodiment, the rigidity indicates the strength of the force necessary for plastic deformation of a predetermined amount. The deformation includes at least compression/extension and bending) In the embodiment, as mentioned above, the angle range of the other portion having a high rigidity (direction to the base 235a) is smaller than the angle range of the one portion having a low rigidity (direction to only the ring 235b). That is, in a straight line passing through two contacting points between the fitting part 621 and the through hole 2351 and the central position of the through hole 2351, when one of the contacting points (first engagement point) is located in the other portion having the high rigidity (in the predetermined angle direction range), the other contacting point (second engagement point) is always located in the one portion having the low rigidity (outside the predetermined angle direction range). The distance between the first engagement point and the second engagement point of the fitting part 622 is longer than the distance between the first engagement point and the second engagement point of the inner edge of the through hole 2351 (fitted part 235). As a result, as the end of the fitting part 621 which is convex is inserted into the through hole 2351, the through hole 2351 is expanded by the selective elastic deformation of the fitted part 235 in the direction of the relatively low rigidity (direction of small Young's modulus), that is, in the direction of extending the ring 235b (low rigidity range, thin portion) (this deformation can also further reduce the thickness on the side in the direction toward the end of the ring 235b from the through hole 2351). The above described different rigidity indicates a rigidity which is intentionally made different greatly, and does not include a gap of the degree of a margin of error. The different rigidity also does not include a change of rigidity which is small compared to the amount of the rigidity such as a nut provided with a hexagon ring around the through hole.

The inserted fitting part 621 is fixed more strongly by the elastic force according to the deformation of the ring 235b. Thus, even if an external force is applied temporarily to the fitting part 621 after the inkjet head 231 was fixed to the fixer 233, for example, even if an unintended force is applied to the attached flow path connector 65 and a force parallel to the fixer 233 is applied to the inkjet head 231, the fitting part 621 returns to the original fixing position with respect to the fitted part 235. Even the portion having the lowest Young's modulus has a high Young's module to such a degree that the movement amount of the inkjet head 231 with respect to the fixer 233 by a slight external force can be sufficiently ignored.

As mentioned above, the inkjet head 231 is forced in the direction toward the base 235a of the fitted part 235, that is, the direction of the dot arrow by the forcing member 236. Thus, the fitting part 622 is pressed in the direction toward the base 235a from the end side of the ring 235b in the through hole 2351. Since the base 235a side (high rigidity range, thick portion) of the through hole 2351 has a large rigidity, the contacting state between the fitted part 235 and the fitting part 622 is maintained almost without changing the deformation amount even if the forcing strength is changed a little. In this state, the deformation amount on the end side of the ring 235b from the through hole 2351 is maintained to be the minimum amount corresponding to the size of the fitting part 622.

For the fitting parts 621, 622 and the fitted parts 234, 235, a material whose deformation amount depending on the temperature is small can be selected. Especially, a material for the fitted parts 234, 235 may be determined to have the thermal expansion coefficient of the fitted parts 234, 235 equal to or less than the thermal expansion coefficient of the fitting parts 621, 622 since the fitting parts 621, 622 are inserted and fixed to specified positions of the fitted parts 234, 235 by the elastic force of the ring 235b or the like and the pressing of the forcer 236.

### MODIFICATION EXAMPLE

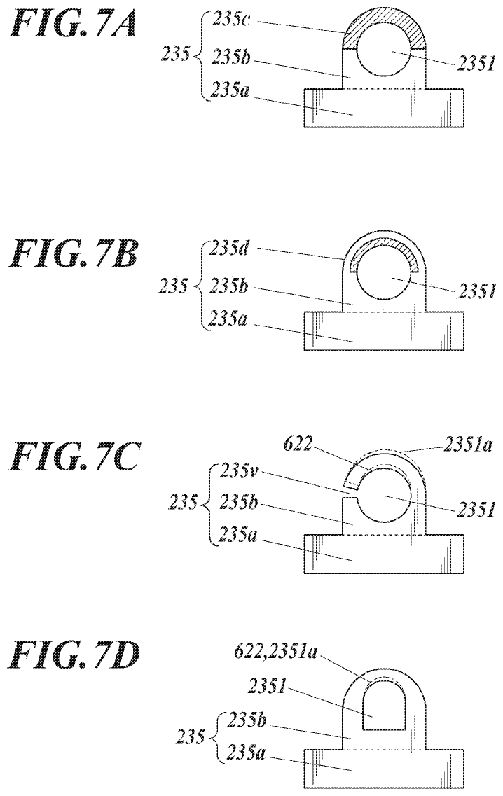

FIGS. 7A to 7D are views showing various modification examples of the fitted part 235.

Though the explanation is made for only the fitted part 235, modifications can also be made similarly for the fitted part 234.

As shown in FIG. 7A, as for the end side portion which is approximately half the ring 235b of the fitted part 235, there may be used, as the end 235c, a material different from the base 235a and the root portion of the ring 235b. By using a material which is easy to perform elastic deformation compared to the other portion as the end 235c, deformation is made to only the end direction selectively by the insertion of the fitting part 622, and the fitting part 622 is pressed toward the direction of not deforming. Thus, the positioning accuracy between the fitting part 622 and the fitted part 235 is improved.

As shown in FIG. 7B, a member having a Young's modulus smaller than that of the base 235a and the like may be used for only a part 235d facing the through hole 2351, not for the entire end of the ring 235b. Thus, the deformation of the outer shape itself of the ring 235b is suppressed small and the positioning accuracy between the fitting part 622 and the fitted part 235 is improved. Especially, in a case where the pressing by the forcer 236 is strong, by positively using a member having a Young's modulus which is small to some degree, it becomes easier to detach the fitting part 622 from the fitted part 235.

As shown in FIG. 7C, a cutout 235v to connect the through hole 2351 with outside of the ring 235b may be provided to the ring 235b. By inserting the fitting part 622, a force corresponding to the bending rigidity functions to the side opposite to the cutout 235v of the ring 235b in the plane of this figure, and the elastic deformation is made so as to expand the width of the cutout 235v. Thereby, the fitting part 622 is fitted to the fitted part 235. In this case, by the elastic force returning the bending functions in the direction of returning the width of the cutout 235v, the fitting part 622 is pressed toward the base 235a side having a small deformation and the fitting part 622 is fixed. In the modification example, the cutout 235v is provided in the 90 degree direction with respect to the central direction of the angle direction range to which the base 235a is connected. Even if the angle direction of the cutout 235v is an angle other than the 90 degree direction, as long as the position of applying the bending stress corresponding to the direction of the cutout 235v is outside the angle direction range to which the base 235a is connected (range having a high rigidity), the deformation of the fitted part 235 corresponding to the stress is effectively generated when the fitting part 622 (inkjet head 231) is inserted and detached, and after the attachment, there is applied a force to fix the fitting part 622 appropriately. By providing the cutout 235v in the 90 degree direction, especially, the entire half on the end side of the ring 235b is easy to deform in the direction separating from the movable base 235a, and the load is easy to disperse.

In a case of locally generating the change of rigidity by the cutout 235v, it is not necessary to provide a large base 235a. Thus, the area occupied by the base 235a on the fixer 233 can be reduced, and it is possible to achieve the efficiency and decrease in the size.

As shown in FIG. 7D, the present invention is not limited to a case where the cross section of the through hole 2351 of the fitted part 235 is in a circle shape and the cross section of the fitting part 622 is in an oval shape. It is sufficient that these are in such shapes that cause a force to function in the direction of returning the change to the original state even if an external force is applied and the positional relationship between the fitting part 622 and the fitted part 235 is temporarily changed. For example, in the modification example, the through hole 2351 and the fitting part 622 are in a rectangular column shape as for the approximately half portion on the base 235a side which is not deformed or has a small deformation amount.

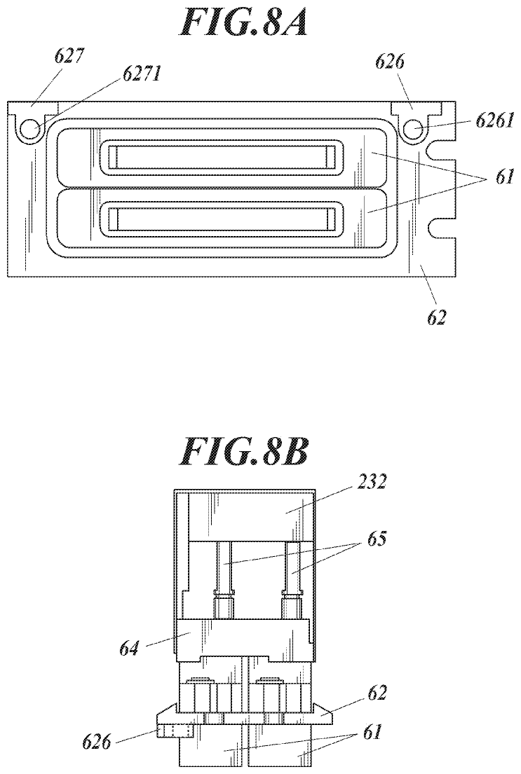

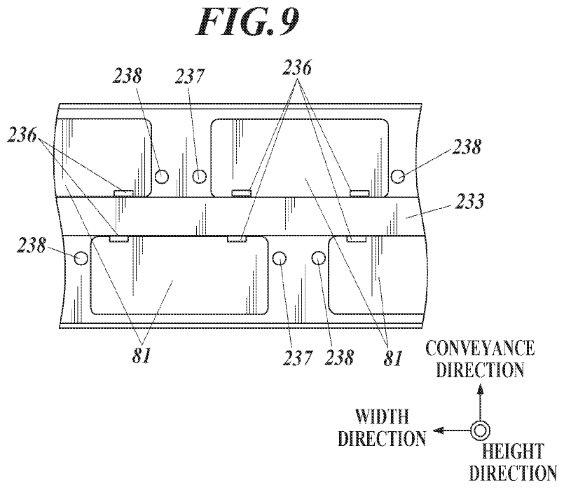

FIGS. 8A and 8B show a modification example of the inkjet head 231. FIG. 9 shows a modification example of the fixer 233. FIGS. 8A and 8B are views of the inkjet head 231 in the modification example seen in the same range from the same direction as those of FIGS. 4A and 4B. FIG. 9 is a view of the fixer 233 of the modification example seen in the same range from the same direction as that of FIG. 5. The same reference numerals are used for the same components.

The substrate 62 of the inkjet head 231 in the modification example (“the other” in the modification example) shown in FIGS. 8A and 8B is provided with the fitted parts 626, 627 instead of the protruding fitting parts 621, 622. On the other hand, the fixer 233 of the modification example (“one” in the modification example) shown in FIG. 9 is provided with protruding fitting parts 237, 238 instead of the fitted parts 234, 235.

In such a way, the fitting part and the fitted part may be provided in reverse between the inkjet head 231 and the fixer 233. Here, for example, the positions of the fitting parts 621, 622 in the fixer 233 may be adjustable as needed. In this case, the positional relationship is such that the base sides of the fitted parts 626, 627 are pressed against the protrusions of the fitting parts 237, 238 by the forcers 236.

As described above, the head unit 23 of the inkjet recording apparatus 1 in the embodiment includes an inkjet head 231 which ejects ink and a fixer 233 to which the inkjet head 231 is fixed. Fitting parts 621, 622 (or fitting parts 237, 238) are provided to be fixed to one of the inkjet head 231 and the fixer 233, and fitted parts 234, 235 (or fitted parts 626, 627) are provided to be fixed to the other of the inkjet head 231 and the fixer 233. The inkjet head 231 is fixed to the fixer 233 by fitting the fitting parts to the fitted parts. In each of the engagement surfaces which are contacted when the fitting parts 621, 622, 237, 238 and the fitted parts 234, 235, 626, 627 are fitted to each other, the rigidity of a portion including a part of the engagement surface is smaller than the rigidity of the other portion in each of the fitted parts 234, 235, 626, 627.

In such a way, the rigidity of a portion including a part of the engagement surface is made smaller than the rigidity of the other portion in the head unit 23. Thereby, it is a little easy to locally deform the fitted parts 234, 235, 626, 627 at the time of fitting and at the time of detachment, and in the attached state, each of the fitting parts 621, 622, 237, 238 is fixed to be pressed more firmly to the portion having a high rigidity according to the elastic force of the deformed portion to return to the original form. Accordingly, in this head unit 23, attachment and detachment can be performed easily without lowering the attachment accuracy between the inkjet head 231 and the fixer 233.

The fitted parts 234, 235, 626, 627 have through holes 2341, 2351, 6261, 6271, and the fitting parts 621, 622, 237, 238 have protrusions (insertion parts) which are inserted into the through holes 2341, 2351, 6261, 6271 and thereby fitted into the fitted parts 234, 235, 626, 627.

In such a way, positioning and fixing can be performed easily with a high accuracy in the head unit 23 since the positioning and fixing are performed by simply inserting the protrusion into the hole.

The fitted parts 234, 235, 626, 627 have different rigidities according to the angle directions from the central positions of the through holes 2341, 2351, 6261, 6271 in a plane orthogonal to the insertion direction of the protrusions of the fitting parts 621, 622, 237, 238. In such a way, by having anisotropy in rigidity and fitting the fitted parts 234, 235, 626, 627 and the fitting parts 621, 622, 237, 238 in an appropriate angle relationship, it is possible to improve the positioning accuracy according to the anisotropy easily.

The protrusions of the fitting parts 621, 622, 237, 238 have columnar structures, and the cross sections of the columnar structures in a plane orthogonal to the insertion direction of the protrusions are larger than the same cross sections of the through holes 2341, 2351, 6261, 6271. That is, the fitting parts 621, 622, 237, 238 are inserted while expanding the narrow through holes 2341, 2351, 6261, 6271. At this time, since the portion having a low rigidity is selectively deformed in a specific direction according to the above-mentioned difference in rigidity, positioning can be performed accurately based on the non-deformed side as a reference. When the fitting parts 621, 622, 237, 238 are pulled out from the through holes 2341, 2351, 6261, 6271, the portion having a low rigidity is deformed appropriately. Thus, an excess load is not applied to the other configuration.

The straight line, which is passing through the first engagement point in the engagement surface included in the other portion having a high rigidity and the central position of each of the through holes 2341, 2351, 6261, 6271, passes through the second engagement point included in the one part having a low rigidity. In a state in which protrusions of the fitting parts 621, 622, 237, 238 are not inserted, at least a part of the distances between the first engagement points and the second engagement points in the columnar structures is larger than the distances between the first engagement points and the second engagement points in the through holes 2341, 2351, 6261, 6271.

Thus, the low rigidity side selectively makes elastic deformation in accordance with the insertion of the columnar structure. Therefore, the positioning can be performed accurately based on the non-deformed side as a reference. Similarly, when the fitting parts 621, 622, 237, 238 are pulled out from the through holes 2341, 2351, 6261, 6271, each portion having a low rigidity is deformed appropriately. Thus, an excess load is not applied to the other configuration. Since the deformed portion returns to the original form after the pulling out, the positioning can be easily and accurately performed similarly when a new inkjet head 231 is attached to the fixer 233.

The fitted parts 234, 235, 626, 627 include rings 234b, 235b and the like which surround the through holes 2341, 2351, 6261, 6271, and bases 234a, 235a and the like which are connected to predetermined angle direction ranges of the rings 234b, 235b and the like. The rigidity in the angle direction ranges to which the bases 234a, 235a and the like are connected is higher than the rigidity of the angle ranges to which the bases 234a, 235a and the like are not connected. Each of the cross sections of the through holes 2341, 2351, 6261, 6271 is in a circle shape, and each of the cross sections of the columnar structures of the fitting parts 621, 622, 237, 238 is in an oval shape having a major axis length larger than the diameter of the circle. The protrusions of the fitting parts 621, 622, 237, 238 are inserted and fitted into the through holes 2341, 2351, 6261, 6271 so that the major axes of the ovals of the columnar structures pass through the centers of the above-mentioned predetermined angle ranges.

In such a way, since fitting is performed so that one end of the portion having the largest diameter of the columnar structure matches the portion having a stably high rigidity, the expanding directions of the through holes 2341, 2351, 6261, 6271 are slanted stably and selectively, and positioning can be performed accurately on the basis of this slanting.

The rigidity is determined according to the thickness from the through holes 2341, 2351, 6261, 6271 of the fitted parts 234, 235, 626, 627 for each angle direction in the plane orthogonal to the insertion direction of the protrusions of the fitting parts 621, 622, 237, 238. That is, since the materials of the fitted parts 234, 235, 626, 627 may not be partially different, it is possible to easily make the rigidity different according to the angle direction.

Each of the fitted parts 234, 235, 626, 627 is divided into two that are the low rigidity range which is continuous in the angle direction in the plane orthogonal to the insertion direction and the high rigidity range having a rigidity higher than the rigidity of the low rigidity range. That is, it is not necessary to form the fitted parts 234, 235, 626, 627 with finely intricate low rigidity ranges (thin portions) and high rigidity ranges (thick portions). It is possible to make the fitted parts 234, 235, 626, 627 deform in ranges of selective angle directions efficiently with an easy configuration.

As shown in FIG. 7C, the fitted parts 234, 235 are provided with cutouts 235v or the like which connect the through holes 2341, 2351 to the outside in the plane orthogonal to the insertion direction of the protrusions such as the fitting parts 621, 622 in the angle ranges having a low rigidity. The angle ranges having a low rigidity include ranges of lowering the rigidity by the cutouts 235v. In such a way, not only using the material and/or thickness of the fitted parts 234, 235, locally lowering the rigidity by the cutouts also generates selective deformation in accordance with the insertion of the protrusions of the fitting parts 621, 622, and thus it is possible to achieve both of maintaining of the positioning accuracy and easiness of the attachment/detachment of the protrusion (that is, inkjet head 231).

The head unit 23 includes forcing members 236 which force the inkjet heads 231 so that the protrusions of the fitting parts 621, 622, 237, 238 are pressed more strongly to the sides on which the rigidity of the fitted parts 234, 235, 626, 627 is relatively high than to the sides on which the rigidity is relatively low in the engagement surfaces. In such a way, the fitted parts 234, 235, 626, 627 and the fitting parts 621, 622, 237, 238 are fitted to each other in a state in which the rigidity is made higher by the forcing members 236, and the gap of the relative positional relationship is not generated. Thus, the positioning accuracy can be improved. Even when a large external force or shock is applied temporarily, the original positional relationship is maintained or recovered more surely. Thus, the positional gap due to the external force or shock is not generated.

In the embodiment, the fitting parts 621, 622, 237, 238 are integrally formed with the inkjet heads 231. If it is sufficient that the inkjet heads 231 and the fixer 233 are uniformly fixed in a predetermined positional relationship, by integrally forming them from the start, it is not necessary to consider the adjustment and gap of the positional relationship between the fitting parts 621, 622, 237, 238 and the inkjet heads 231, and fixing can be performed by performing positioning more easily and surely with a high accuracy without using the adjusters 84.

The fixer 233 is provided with adjusters 84 for adjusting the positions of the fitting parts 237, 238 or fitted parts 234, 235 to be fixed. By performing positioning between the fixer 233 and the fitting parts 237, 238 and the fitted parts 234, 235 in advance, it is possible to fix the inkjet heads 231 to the fixer 233 with a high accuracy easily and surely by just fitting the fitted parts 626, 627 and the fitting parts 621, 622 to the positioned parts.

The thermal expansion coefficient of the fitted parts 234, 235, 626, 627 is equal to or less than the thermal expansion coefficient of the fitting parts 621, 622, 237, 238. In such a way, by more suppressing the thermal expansion of the fitted part sides to be small, the stress distribution of the sides to which the protrusions are inserted is difficult to change non-uniformly, and it is possible to suppress the lowering of the positioning accuracy.

The inkjet recording apparatus 1 in the embodiment includes the above head unit 23. Thus, it is possible to easily perform positioning of the inkjet heads 231 with a high accuracy, and easily perform replacement and positioning again when the inkjet head 231 is broken, for example. Accordingly, the image recorded by the inkjet recording apparatus 1 is maintained with a high image quality easily.

the present invention is not limited to the above embodiment, and various modifications can be made. For example, in the above embodiment, the cross section of the columnar structure of the fitting part is larger than the cross section of the through hole. However, the cross section of the columnar structure may be the completely same size as that of the cross section of the through hole. Since there is a portion having a low rigidity, it is possible to reduce the friction at the time of insertion to perform fitting in an appropriate positional relationship and perform detachment.

In the embodiment, the protrusion of the fitting part is attached to the through hole. However, the hole may not be a through hole according to the relationship with the length of the protrusion as long as the rigidity is different according to the angle in the plane orthogonal to the insertion direction of the protrusion.

In the embodiment, the fitted parts 234, 235, 626, 627 are shown as combinations of the rings and the bases. However, the fitted parts 234, 235, 626, 627 may have a shape which cannot be divided clearly, for example, a cross sectional shape of a circle having a radius and a center different from the through hole. The combination of different materials and the formation of the cutout shown in the modification examples may be combined.

In the embodiment, the forcing members 236 are provided. However, the forcing members 236 may not be provided. The number of the forcing members 236 does not need to be two, and when a plurality of forcing members 236 are provided, all the forcing members 236 do not need to force the inkjet head 231 in a same direction.

In the embodiment, the fitting parts and the fitted parts are integrally formed with respect to the inkjet head 231, and the positions of the fitting parts and the fitted parts can be adjusted with respect to the fixer 233. However, the configuration may be opposite. In the embodiment, two pairs of the fitting parts and the fitted parts are provided to one inkjet head 231, and the position adjustment can be performed for all of them. However, the position adjustment can be performed for only one of them, for example, only one of the two fitted parts 234, 235.

Any configuration according to the above embodiment may be applied to only one pair of the two pairs of the fitting parts and the fitted parts. That is, the other pair may have a conventional through hole in an elongated hole shape, and combine the fitted parts not having the difference in rigidity according to the angle direction and the fitting parts which are inserted into the fitted parts and fixed at appropriate positions. In this case, the extending direction of the elongated hole may be limited to the width direction, and the thick portion and the thin portion may be formed at respective sides in the conveyance direction orthogonal to the elongated hole similarly to the above. Thus, one pair of the fitting part and the fitted part defines the position, and the other pair of the fitting part and the fitted part defines the angle position in the rotation direction. By providing an elongated hole in the width direction, it is possible to deal with the gap of the distance between both of the fitting parts 621, 622 according to the expansion due to the difference in temperature condition and the like.

The embodiment has been described by taking, as an example, fitted parts each of which is formed with a single member. However, the fitted part may be formed by combining a plurality of members. The fitting part may be formed to have a protrusion provided to a base or the like and attached to the inkjet head 231, the fixer 233, or the like.

The present invention is not limited to a case of dividing the fitted part into two which are the high rigidity range and the low rigidity range. It is sufficient that elastic deformation is partially performed appropriately at the time of insertion and the pulling out of the fitting part, and the portion which is not deformed (or which is little deformed) is a reference of the positioning.

The embodiment has been described by taking, as an example, a combination of fitting part and fitted part which are fitted to each other by inserting the protrusion into the through hole. However, the present invention is not limited to this as long as the parts are fixed and engaged so as to be attachable and detachable. For example, a plurality of gears may be engaged.

As for the other specific details of configurations, structures and the like shown in the embodiment, modifications can be made as needed within the scope of the present invention. Although embodiments of the present invention have been described and illustrated in detail, the disclosed embodiments are made for purposes of illustration and example only and not limitation. The scope of the present invention should be interpreted by terms of the appended claims

The entire disclosure of Japanese Patent Application No. 2018-143323, filed on Jul. 31, 2018, including description, claims, drawings and abstract is incorporated herein by reference in its entirety.

What is claimed is:

1. A head unit comprising:
an inkjet head that ejects ink; and
a fixer to which the inkjet head is fixed, wherein
an engaging part is provided to be fixed to one of the inkjet head and the fixer, and an engaged part is provided to be fixed to the other,
the inkjet head is fixed to the fixer by engaging the engaging part and the engaged part, and
in the engaging part or the engaged part, a rigidity of a portion including one part of an engagement surface on which the engaging part and the engaged part engage with each other is lower than a rigidity of the other portion.

2. The head unit according to claim 1, wherein
the engaged part has a hole, and
the engaging part has an insertion part that is engaged with the engaged part by being inserted into the hole.

3. The head unit according to claim 2, wherein the rigidity of the engaged part is different according to an angle direction from a central position of the hole in a plane orthogonal to an insertion direction of the insertion part.

4. The head unit according to claim 2, wherein the insertion part has a columnar structure, and a cross section of the columnar structure in a plane orthogonal to an insertion direction of the insertion part is larger than a cross section of the hole in the plane orthogonal to the insertion direction.

5. The head unit according to claim 4, wherein
a straight line, which passes through a first engagement point in the engagement surface included in the other portion and a central position of the hole, passes through a second engagement point included in the one part, and
in a state in which the insertion part is not inserted, at least a part of a distance between the first engagement point and the second engagement point in the columnar structure is larger than a distance between the first engagement point and the second engagement point in the hole.

6. The head unit according to claim 4, wherein
the engaged part includes a ring that surrounds the hole and a base that is connected to a predetermined angle direction range of the ring, and the rigidity of the angle direction range to which the base is connected is higher than the rigidity of an angle range to which the base is not connected,
a cross sectional shape of the hole is a circle, and a cross sectional shape of the columnar structure is an oval that has a major axis longer than a diameter of the circle, and
the insertion part is engaged with the hole by being inserted into the hole so that the major axis of the oval passes through a middle of the predetermined angle direction range.

7. The head unit according to claim 3, wherein the rigidity is determined according to a thickness of the engaged part from the engagement surface of the hole for each of the angle direction in the plane orthogonal to the insertion direction.

8. The head unit according to claim 3, wherein the engaged part is divided into two of a low rigidity range and a high rigidity range, the low rigidity range being continuous in the angle direction in the plane orthogonal to the insertion direction of the insertion part, and the high rigidity range having the rigidity higher than the rigidity of the low rigidity range.

9. The head unit according to claim 2, wherein a cutout that connects the hole to an outside in a plane orthogonal to an insertion direction is provided to the portion including the one part in the engaged part.

10. The head unit according to claim 2, comprising a forcer that forces the inkjet head so that the insertion part is pressed more strongly to a side on which the rigidity of the engaged part in the engagement surface is relatively high than to a side on which the rigidity is relatively low.

11. The head unit according to claim 1, wherein at least a part of the engaging part and the engaged part is formed to be integrated with at least a part of the inkjet head and the fixer.

12. The head unit according to claim 1, wherein an adjuster for adjusting a position of the engaging part or the engaged part to be fixed is provided to the fixer.

13. The head unit according to claim 1, wherein a thermal expansion coefficient of the engaged part is equal to or less than a thermal expansion coefficient of the engaging part.

14. An inkjet recording apparatus comprising the head unit according to claim 1.
